(19) United States
(12) Patent Application Publication
(10) Pub. No.: US 2025/0017709 A1
(43) Pub. Date: Jan. 16, 2025

(54) ALTERNATING FINGER IN AN ARCH OF A BRUSHING MOUTHPIECE

(71) Applicant: KONINKLIJKE PHILIPS N.V., EINDHOVEN (NL)

(72) Inventor: Scott E. HALL, Issaquah, WA (US)

(21) Appl. No.: 18/711,841

(22) PCT Filed: Nov. 22, 2022
(86) PCT No.: PCT/EP2022/082838

§ 371 Date: May 20, 2024

Related U.S. Application Data
(60) Provisional application No. 63/282,044, filed on Nov. 22, 2021.

(51) Int. Cl. A61C 17/22; A46B 5/00; A46B 9/00; A46B 9/02; A46B 9/04; A46B 13/04; A46D 1/00

(52) U.S. Cl. CPC A61C 17/228; A46B 5/0025; A46B 9/005; A46B 9/026; A46B 9/028; A46B 9/045; A46B 13/04; A46D 1/02

(57) ABSTRACT

A dental appliance and method employing an arcuate mouthpiece with a plurality of substantially H-shaped plate segments having opposing side walls joined by transverse bridge portions splitting the opposing side walls into upper and inverted channels dimensioned for receiving the teeth in the maxillary dental arch and mandibular arches respectively so that one or more cleaning modules, such as tufted bristles, may be activated to simultaneously clean a working surface of the teeth of the maxillary dental arch and the teeth of the mandibular dental arch adjacent to the plate segments.

### TECHNICAL FIELD

This invention relates generally to oral cleaning appliances, and more specifically concerns such an appliance which has a workpiece/bristle assembly enabling simultaneous cleaning or treatment of multiple teeth which is conformable to individual oral anatomies.

### BACKGROUND OF THE INVENTION

It is well known that a mouthpiece for brushing several teeth at once should fit a user's oral geometry. Fit is important since the space between the individual teeth and the tufted surface directly relates to forces imparted by the bristle tips which in turn corresponds to the effectiveness of the plaque removal. Hence, teeth cleaning and plaque removal entails adaptive conformity to fit about a user's dentition.

However, dental anatomy variables are many and varied, and include teeth of differing sizes, dentition with highly variable curvatures, a full mouth, and misaligned upper and lower arches, malocclusions, bony artifices, among others.

Dimensional variation of individual teeth common to most dentition presents one challenge. Inconsistencies in surface area and corresponding width and length of a single tooth entail adaptations in any nominal design. Application of a brushing or cleaning mouthpiece to a plurality of teeth entails an additional level of adaptive fit corresponding to their relative position and orientation. Such adaptive fitting measures are further exacerbated at transition zones in the mouth, namely, between the molars/premolars and canines, and between the canines and incisors. In these zones, marked divergences of the teeth require commensurate adaptability of the bristle tips and positioning mechanisms.

Beyond such common variables of dental arches and teeth, a number structural aberrations encountered of dental arches exhibiting atypical geometric impart further challenges to efficacious fitting of a mouthpiece requisite to situate bristles of acceptable proximity in order to simultaneously clean a plurality of teeth.

Hence, in order for an oral hygiene appliance, such as a toothbrush or a dental cleaning mouthpiece, to be effective in cleaning teeth, it must be able to both access all the teeth and generally conform to the oral geometry of the teeth during cleaning. Conventional dental appliances for efficacious cleaning across varying oral geometry of the teeth may employ bristle trim contour or intermittent bristle extensions seen in toothbrushes. These prior art dental brushing systems may alternatively and additionally utilize bristle stiffness, tapered, or cantilevered tufted portions that vary along the length of the bristle surface.

Attempts to enhance adaptive fit of past brushing appliances include spring elements, which may be incorporated with or without various bristle configurations and cantilevering. However, space for the spring element consumes some of the tuft working surface and can limit performance and comfort.

Furthermore, particular bristle tip configurations are typically useful for broad categories of users, and limited, if any, capability of conformance with the oral geometry of individual users. Limitations of bristle arrangements render them incapable of cleaning teeth areas of dental arches with certain structural anomalies, especially when pronounced. Where there are specific teeth areas which are difficult to clean and hence susceptible to oral disease, designing a brushing mouthpiece to access such areas are of particular concern.

Prior art dental appliances have also incorporated a deformable bristle substrate providing adaptive conformance to a user's teeth. Some such systems employ an elastomer providing a flexible substrate. However, attenuation of pressure exerted by the drive system by the elastomer material can limit transmission of motion to the bristles of a power toothbrush and thus diminish their teeth cleaning efficacy.

In addressing such and other shortcomings of passive adaptation of brushing mouthpieces, auxillary mechanisms have been proposed. For example, it has been proposed to utilize active or robotic elements and functions such as described in U.S. Pat. No. 9,517,119, customized fit such as described in U.S. Pat. Pub. No. 2018/0116773, spring elements, and a segmented mouthpiece such as described in U.S. Pat. No. 8,793,830.

Such and other drawbacks of conventional systems employed in mouthpieces for simultaneous cleaning of multiple teeth limit their efficacy. For example, connections between a mouthpiece base plate and attached brushing elements may exert excessive compression on filaments attached to the fingers. In some systems, terminal rims or ends of mouthpiece troughs exert insufficient pressure on the brushing elements to clean debris and plaque from the teeth.

As can therefore be surmised, conventional brushing mouthpieces have not provided a system integrating adaptive conformance of the bristle assembly to the teeth while transmitting sufficient working motion to bristles for effective cleaning of a plurality of teeth in the maxillary and mandibular dental arches. Such and other drawbacks thus continue to limit the efficacy of brushing mouthpieces. Accordingly, there is a persisting need for an adaptive oral cleaning system for efficacious cleaning of a plurality of teeth in a user's maxillary and mandibular dental arches.

### SUMMARY OF THE INVENTION

Accordingly, there is disclosed and claimed herein a dental cleaning appliance and method for simultaneously cleaning one or more teeth in a maxillary dental arch and one or more teeth in a mandibular dental arch including an include an arcuate mouthpiece for fitting upon at least a portion of a user's mouth. The arcuate mouthpiece includes H-shaped plate segments having a transverse bridge portion between opposed walls, and may also include plate segments assembled to form a in a full or partial U-shaped or J-shaped mouthpiece.

On a top side of the bridge portion is an upper channel with rims dimensioned for receiving teeth of the maxillary dental arch and disposed on an upper side is an inverted channel dimensioned for receiving teeth of the mandibular dental arch.

Between the plate segments are non-rigid members sized to couple plate segments such that the plate segments (8) are capable of adaptively positioning inner surfaces of the upper and inverted channels to simultaneously fit proximal to a working surface of the teeth in the maxillary dental arch and the mandibular dental arch. In some embodiments, the non-rigid members are dimensioned such that plate segments with a descended bridge portion are proximally spaced between plate segments with an elevated bridge portion so as to facilitate adaptive fit of the upper channels and the inverted channels of the plate segments.

Cleaning modules may be disposed on inner surfaces of the upper and inverted channels such that a driving mechanism is capable of activating the cleaning modules so as to simultaneously clean a working area of teeth of the maxillary and mandibular arches adjacent to the plate segments.

In some embodiments, the opposing side walls have terminal ends of single layer portions and folded ends with abutted inner layer portions that meet in a transverse bridge portion joining the opposing side walls. In some embodiments, the plate segments are configured such that the terminal single layer of the side walls is flexibly adaptive to a working surface of the teeth. Embodiments may also include alternating plate segments with elevated and descended bridge portions. In some embodiments, the plate segments with elevated bridge portions are spaced between plate segments having descended bridge portions.

In some embodiments, the driving mechanism may be a pneumatic device in communication with the arcuate mouthpiece so as to be capable of pressurizing and depressurizing aspects of the dental appliance. Such a pneumatic device may activate the cleaning modules. The pneumatic device may be employed to pressurize and depressurize a bladder or a flexible wall portion, as further detailed below.

Various embodiments may further feature a handle to facilitate insertion and positioning the arcuate mouthpiece in the mouth of the user. In some embodiments, the pneumatic device may be positioned within the handle.

The plate segments may be variously configured in accordance with the geometry of a user's teeth. That is, side walls of plate segments of a portion adapted to receive molars would extend in a substantially perpendicular orientation for the base member while side walls corresponding to portions designed to receive canines and incisors may be reduced and tapered to fit their respective geometry. The plate segments may be constituted of any safe and durable material of sufficient rigidity to translate motion and pressure producing sufficient friction to remove debris, bacteria, and plaque from the teeth of a user. Exemplary suitable materials include rigid or semi-rigid biocompatible polymers, carbon fibers, and metal insert molded into a polymer

In some embodiments, opposed ends of the arcuate mouthpiece may be attached by non-rigid element(s) joined to opposed terminal plate segments.

The components of the arcuate mouthpiece may be composed of any suitable biocompatible material. The non-rigid members should include a pliable material or moveable element capable of imparting flexible rotation about the plane of the base plate and adaptive conformance to adjacent teeth. For example, the composition of the non-rigid members could include a range of materials such as, for example, silicone, memory foam, rubber, flexible polymer, or similar a flexible fabric or film. Non-rigid members could also employ moveable mechanical elements such as, for example, hinges, sliders, flexible beams, or springs.

Embodiments of the dental appliance described herein may further include a base portion configured for facilitating positioning of the arcuate mouthpiece about the teeth of the maxillary dental arch and the teeth of the mandibular dental arch. In some embodiments, the base portion may segmented, hinged or otherwise imparted with adaptive flexibility by insertion of moveable or pliable materials. The base portion may also include a bladder.

Embodiments may further employ a bladder as a non-rigid member or a flexible wall portion deformable when pressurized and depressurized by a pneumatic device. Sizing versatility imparted by inflating and deflating soft bladders provides a high level of adaptive conformance of the plate segments with cleaning modules for more pronounced deviations in dental geometry.

The plate segments of this arcuate mouthpiece may be attached to the non-rigid members by commercially available materials and known techniques. For example, conventional laser seaming or other joining systems such as, for example, insert molding, or co-molding, as well as ultrasonic welding may be used. Intermediary members could be inserted or integrally molded with plate segments. Such known attachment and molding techniques can similarly be applied to join plate segments to a base member and flexible platform of the arcuate mouthpiece.

Various structural arrangements to accommodate a variety of dental arch and teeth geometries. Some embodiments to adjust to atypical dental geometry such as where the maxillary dental arch is nested behind or inside of the mandibular dental arch, rather than the converse normal converse orientation of a mandibular dental arch nested behind or inside of the teeth of the maxillary dental arch.

Cleaning modules toward terminal ends of the inner surfaces of the plate segments' side walls may be configured structurally and also employ various elements and agents for removing debris and plaque from teeth. For example, cleaning modules in some embodiments may include bristles in various tuft configurations. Bristle pads are configurable to reach corresponding contours of a user's oral anatomy. In addition, bristle length may be graduated or tapered, or variable based on corresponding tooth geometry and dentition sensitivity. Bristle stiffness may also be varied to correspond with a particular dental arch anatomy and/or application.

In various embodiments, spring element(s) may be employed to enhance cleaning teeth of dental arches exhibiting particular or pronounced anomalies. Inclusion of spring elements in the design may be utilized to extend tuft length and to reduce bristle stiffness.

Some embodiments may provide cleaning modules with apertures configured for ejecting fluids onto user dentition. Such applications of fluid may be combined with bristles or used alone. Suitable fluids include water, saline, mouthwash, and other liquid treatment agents for the dentition and/or mouth of a user.

The subject matter described herein further includes a methodology of providing a dental cleaning appliance as described above, positioning the arcuate mouthpiece in the mouth of the user, activating the cleaning modules to simultaneously clean one or more teeth of the maxillary and mandibular dental arches, cleaning the teeth for a suitable time, and removing the dental cleaning appliance when the operation is completed.

Numerous advantages ensue from the dental appliance and methodology described herein that may include one or more of the following. The device and system enhances and speeds cleaning and/or dental treatment operations. The device and system can be used to clean teeth and arches of varied geometries, including dental malocclusion, wide, shallow as well as, deep and narrow dental arches, deviant or irregular positioning of maxillary and mandibular arches, boney defect system and other anomalies or structural irregularities of a user's dentition.

Thus, it can be seen that particular advantages of this device and system accrue from the adaptable conformability to accommodate non-uniformity of teeth geometry. That is, adaptive versatility of the mouthpiece design adjusts cleaning modules to common variations tooth width and relative positioning of dental arches. In particular, properties imparting flexible composition, moveable elements, and/or capability of variable sizing, configuration and compositions of the non-rigid members, base portion and/or plate segments facilitate adaptive fit of the cleaning modules. Such and other variable elements provide proximity facilitating access for simultaneous cleaning of the maxillary and mandibular dental arches, notwithstanding atypical dental geometry and/or untoward. For example, versatile adjusting of non-rigid components facilitate accommodating a full dental arch with highly varied curvatures, a wide and “shallow” or, conversely, narrow and “deep” dentition in addition to typical variation in the size and/or number of teeth. Yet another advantage of the embodiments described herein is that the flexibility of the design enables differential cleaning of different surface curvatures of the teeth and mouth, enabling performance that is customizable to the user.

Embodiments of the invention may include potential for alternating or separately cleaning teeth in the maxilla and the mandible, or in a dual-arch manner. Furthermore, the device and system can be used to treat cases presenting with a full dentition, any combination of naturally or unnaturally missing teeth. The device and system may be employed for and by user of any age and medical history profile including infirm and elderly.

A still further advantage is the simultaneous cleaning of teeth of maxillary and mandibular dental arches more uniformly, thoroughly and efficiently cleaning multiple teeth in a shortened time.

It should be appreciated that all combinations of the foregoing concepts and additional concepts discussed in greater detail are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

FIG. 1 is a perspective view of dental cleaning appliance 100 showing plate segments 8 with elevated and descended bridge portions 20 in alternating sequence in dashed or phantom lines.

FIG. 2 is a perspective view of a partial arcuate mouthpiece 6 showing the configuration of plate segments 8 relative to non-rigid members 30 and base portion 34, partially shown in dashed or phantom lines.

FIG. 3 is a simplified cross-sectional diagrams showing a cross-section of the plate segment 8 and arrangement of components of FIG. 3 relative to the teeth.

FIG. 4 is a simplified diagram of plate segments 8 and non-rigid members 30.

FIG. 5 is a simplified diagram showing working area of the plate segments 8 relative to non-rigid members 30 when unassembled.

FIG. 6 is a flow chart showing the successive steps employing dental appliance 100 to accomplish a teeth cleaning operation.

### DETAILED DESCRIPTION OF THE VARIOUS EMBODIMENTS

The disclosed subject matter will become better understood through review of the following detailed description in conjunction with the figures. The detailed description and figures provide example embodiments of the invention described herein. Those skilled in the art will understand that the disclosed examples may be varied, modified, and altered without departing from the scope of the invention described herein.

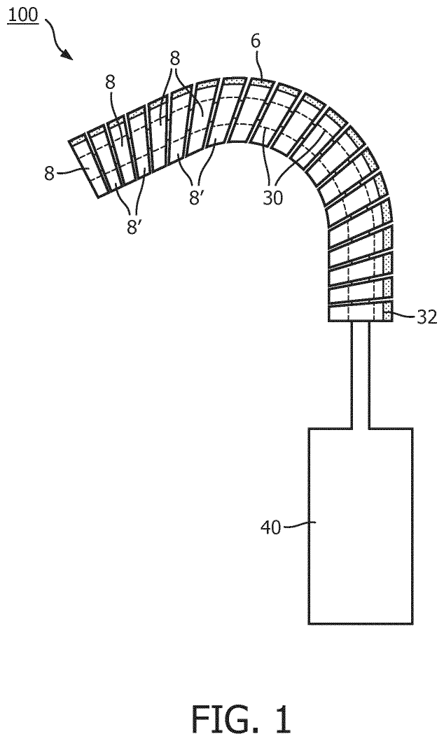

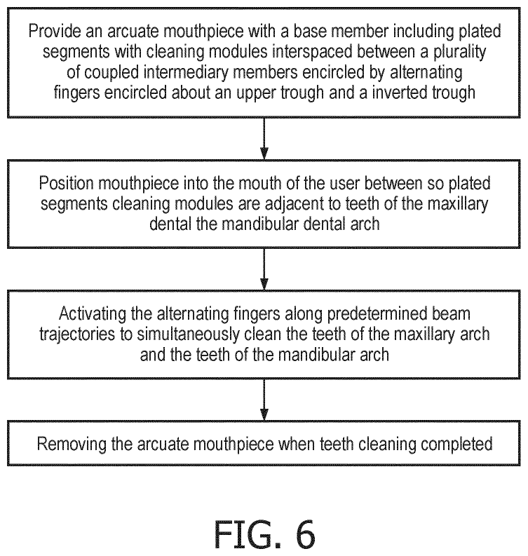

Throughout the following detailed description, representative examples of features of are disclosed to illustrate aspects of the claimed invention. Related features in the examples may be identical, similar, or dissimilar. The reader should understand that a given feature need not be the same or similar to the specific portrayal. It should therefore be understood that the representative embodiments illustrated in FIGS. 1-6 are adapted to a power brushing mouthpiece. However, it should be understood that the claimed and described features of other embodiments of the claimed invention may be adaptable to other applications, including, for example, flexible or foam material cleaning mechanism, fluid ejection cleansers, and dental treatment and bleaching applications.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used in the specification and in the claims, “or” is synonymous to “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

As used herein, an “arcuate mouthpiece” refers to any suitable dental appliance for receiving the teeth of a user. The shape is generally curved, and can be configured in a wide or shallow U, partial U, C, or J configuration for receiving all or a part of the user's teeth.

As used herein, “H-shaped” as applied to the described and claimed plate segments refers generally to any configuration having a transverse bridge portion 20 that join opposing side walls 10. The side walls 10 can be perpendicular or angled, linear or curvilinear, and dimensioning to adaptively conform rims of opposed upper cavities on top of the bridge portion and lower cavities below the bridge portion to corresponding maxillary and mandibular dental arches. The term “H-shaped” is thus defined to include derivations that may include variously shaped plate segments having stacked upper and inverted channels and may include configurations more akin to a “X”, a stacked upward on an inverted “U” and similar shapes thereby forming variously dimensioned stacked upper channels 22 and inverted channels 24. Hence, although the upper and lower channel rims may be mirrored shapes, embodiments may include asymmetrical an/or dissimilarly shaped or sized channels. The “elevated bridge portion” 20 of the plate segments 8 refers to positioning the transverse bridge portion 20 joining the opposing walls of the “H-shaped” plate segments 8 above its mid-section. The “descended bridge portion” 20′ of the plate segments 8′ refers to positions below its mid-section.

As used herein, a “driving mechanism” refers to any mechanical, electrical, electromechanical, vibratory, ultrasonic, pneumatic or computer-enabled power or pressure source suitable for intraoral applications. For example, batteries may drive electrical motors for intraoral embodiments. Facile embodiments may employ small coin batteries, alkaline or lithium, and rechargeable batteries. Any off-the-shelf on/off switch can be used to activate the driving mechanism. As can be readily seen, the driving mechanism may be activated and deactivated by an on/off switch with depressible activator (push button, rocker or membrane button).

Now referring to the various figures illustrating an exemplary embodiment of the claimed invention as illustrated in FIGS. 1-6, there is illustrated a dental cleaning appliance 100 for simultaneously cleaning teeth in a maxillary dental arch 2 and a mandibular dental arch 4. The arcuate mouthpiece 6 includes plurality of plate segments 8 configured as H-shaped members having opposing side walls 10. Each of the side walls 10 has a terminal end 12 of a single layer portion 14 extending to a folded end 16 and doubles back to form an abutting inner layer portion 18. Inner layer portions 18 of opposing side walls merge a transverse bridge portion 20 between side walls 10 such that terminal ends 12 and folded ends 16 of opposing side walls 10 are flipped in transverse juxtaposition. Opposing side walls 10 are split by the bridge portion 20 to form an upper channel 22 dimensioned for receiving at least one of the teeth of the maxillary dental arch 2 is disposed on an upper side of the plate segments (8) and an inverted channel 24 dimensioned for receiving at least one of the teeth of the mandibular dental arch 4 is disposed on the underside of the plate segments (8) beneath the upper channel 22.

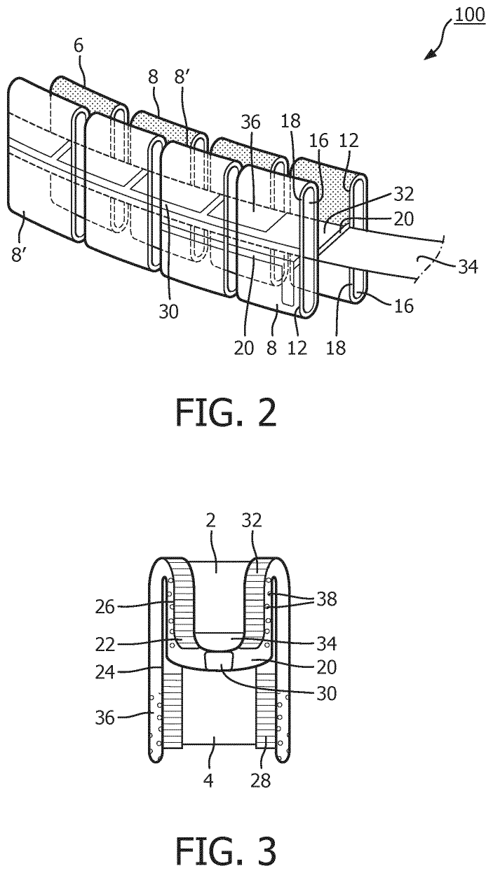

Still referring to FIGS. 2 and 3, non-rigid members 30 couple plate segments 8 so as to adaptively position an inner surface 26 of upper channels 22 proximal to a working surface of the teeth in the maxillary dental arch 2 and an inner surface 28 of inverted channels 24 proximal to a working surface of the teeth in the mandibular dental arch 4 so as to enable adaptive fit of the upper channels 22 and the inverted channels 24 about the teeth in the maxillary dental arch 2 and mandibular dental arch 4 adjacent to the plate segments 8.

Driving mechanism 40 is connected to the arcuate mouthpiece 6 that activates cleaning modules 32 disposed on the inner surfaces. In some embodiments, driving mechanism 40 may be a pneumatic device.

Along the inner surfaces 24, 26 of plate segments 8 extending from terminal ends of side walls 10 forming rims of channels are one or more cleaning modules (30). Activation of driving mechanism 40 activates cleaning modules 30 so as to simultaneously clean the teeth of the maxillary dental arch 2 and the teeth of the mandibular dental arch 4 adjacent to the plate segments 8.

For a molar fit of adult teeth, typical dimensions of the upper opening of H-shaped plate segment 8 are contemplated to measure in the following ranges. Length of the outer rim of channels may be 6 to 12 mm while a typical corresponding inner rim would measure 4 to 7 mm. The open sides of the channel could typically measure 4 to 10 mm.

As detailed above, non-rigid members 30 may consist of a variety of materials or moveable members. Various embodiments may further employ a range of non-rigid members 30 including hinges, sliders, elongate beams, flexible fabric, flexible walls, and films. Some embodiments may include non-rigid members 30 having one or more bladders configured to be inflatable by a pneumatic device when pressurized to inflate the bladders and to deflate when depressurized.

Now referring to FIG. 1 as well as 2, bridge portions 20 of plate segments 8 may be differentially spaced such that the plate segments 8′ with a descended bridge portion 20′ are disposed between plate segments 8 having an elevated bridge portion 20 and wherein the non-rigid members 30 are dimensioned such that plate segments 8′ with a descended bridge portion 20′ are proximally spaced between plate segments 8′ having an elevated bridge portion 20. In the latter embodiments, one series of non-rigid members 30 are sized and spaced to connect edges of the plate segments 8 having an elevated bridge portion 20 and a separate series of non-rigid members 30 are sized and spaced to connect the plate segments 8′ having a descended bridge portion 20′ such that the plate segments 8 are nested between adjacent plate segments 8′.

As illustrated in FIGS. 2 and 3, base portion 34 may also be provided for supporting positioning of arcuate mouthpiece 6. Base portion 34 may be interfaced with corresponding plate segments 8 and non-rigid members 30 to thereby facilitate positioning the arcuate mouthpiece when simultaneously cleaning the working surface of the teeth of the maxillary dental arch 2 and the working surface of the teeth of the mandibular dental arch 4 adjacent to plate segments 8. Base portion 34 may be composed of various materials, segmented, notched, hinged or embedded with springs or composed of materials of varied stiffness. In some embodiments, base portion 34 may be a bladder of include flexible wall portion(s).

Now referring to FIG. 1 as well as FIG. 2 showing mostly by dashed, phantom lines depicting concealed elements of the illustrated dental appliance, bridge portions 20 may be differentially spaced such that the plate segments 8′ having a descended bridge portion 20′ may be disposed between plate segments 8 having an elevated bridge portion 20, and non-rigid members 30 are dimensioned such that plate segments 8′ with descended bridge portion 20′ are proximally spaced between plate segments 8 having an elevated bridge portion 20. As depicted in FIGS. 1-3, a first series of non-rigid members 30 are sized and spaced to connect edges of the plate segments 8 having an elevated bridge portion 20 and a separate series of non-rigid members 30′ are sized and spaced to connect the plate segments 8′ having a descended bridge portion 20′ such that the plate segments 8 are nested between adjacent plate segments 8′.

Non-rigid members 30 are spaced to allow plate segments 8 to flex and thereby translate and rotate freely along the plane of the arcuate mouthpiece. In some embodiments, such as illustrated in FIGS. 1-6, the lengths of plate segments 8 and spaces between them are about the same size. To so space plate segments 8, lengths of non-rigid members 30 between alternating plate segments 8, 8′ typically measure less than 1 tooth and is closer to 0.5 teeth. For typical teeth, the non-rigid members 30 measure about 4-8 mm.

As also illustrated partially by dashed phantom lines depicting concealed portions of the perspective views of FIGS. 1 and 2, base portion 34 may be successively positioned beneath successive elevated bridge portions 20 of plate segments 8 and above descended bridge portions 20′ of plate segments 8′. Non-rigid members 22 are dimensioned such that plate segments 8′ with a descended bridge portion 20′ are proximally spaced between plate segments 8′ having an elevated bridge portion 20 and wherein a first series of non-rigid members 30 are sized and spaced to connect edges of the plate segments 8 having an elevated bridge portion 20 and a second series of non-rigid members 30 are sized and spaced to connect the plate segments 8 having a descended bridge portion 20′ such that the plate segments 8 having an elevated bridge portion 8 are nested between the plate segments 8 having a descended bridge portion 20.

Another feature of the exemplary embodiment shown in FIG. 3 is a flexible wall portion 36 in inner surface 26 of upper channel 22 and/or inner surface 28 of inverted channel 24. The flexible wall portion 36 may be configured to be deformable when a pneumatic device pressurizes and depressurizes the flexible wall portion 36.

Cleaning modules 32 may also include apertures 38 for ejecting a fluid such as, for example, water, a bleaching or other dental treatment agent.

Cleaning modules 32 may also employ a variety of materials, textures, and structures. For example, a foam pad, abrasive surface, jets of fluid, and tuft of bristles of differing lengths and stiffness, alone or combined, could be used. In some embodiments, the tufted bristles may be tapered to lengthen toward the terminal ends of the plate segments 8 and shorten toward the bridge portion 20 of the plate segment 8. Tufted bristles may also vary in stiffness so they are more rigid toward terminal ends 12 of plate segments 8 and more flexible toward bridge portions 20.

Although illustrated for molar teeth applications in the figures, in various other embodiments, one or more of the side walls 12 of plate segments 8 may be configured for fitting a corresponding geometry of the teeth.

Contours of side walls 10 or rims for fitting other teeth, including premolar, incisors, an canine, can be adapted to angle inwardly to form more of an X-shaped, asymmetrical and/or curvilinear configuration. Such derivations of plate segment 8 as described and claimed herein are included in the definition of H-shaped, as detailed in above.

Materials and elements imparting the desired flexibility for none-rigid member 30 can include hinges, sliders, long beams, a bladder or bladders, fabrics or films. This can be co- or insert-molded with the plate or assembled independently. The length of non-rigid members 30 in arcuate mouthpiece 6 can vary to accommodate the corresponding teeth and/or dental arch geometry.

In certain embodiments such as exemplified in FIGS. 1-6, plate segments 8 may be nested together between non-rigid members 30 in order to facilitate adequate working area. In some embodiments, plate segments 8 could be connected to a bladder or to each other at a position near terminal ends where any stiffness of non-rigid members 30 would be attenuated by terminal end flexibility and thus provide adaptive movement to fit the teeth of the user.

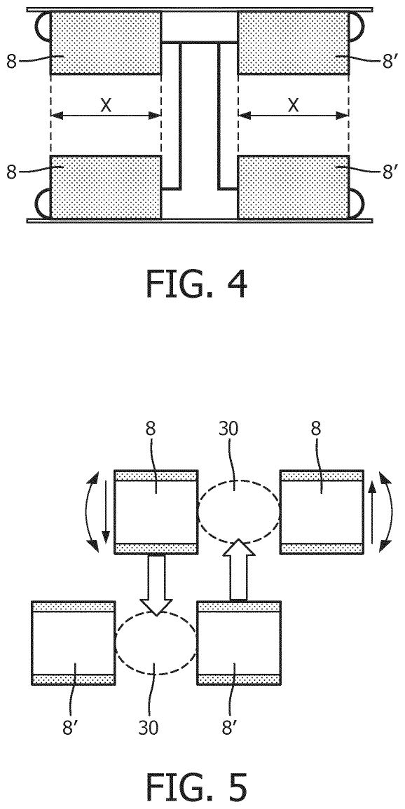

Now referring to FIG. 4, a schematic representation depicts an unassembled view showing with the bold arrows designating how alternating plate segments (8) are nested with non-rigid members 30 between adjacent plate segments. FIGS. 4 and 5 further illustrate the motion of cleaning modules 32 along work area X. As shown, the illustrated configuration of the dental appliance 100 imparts a beam such that for every distance x that the beam routes away from the work area the length is increased by 2× and the stiffness is an inverse to the cube of the length. It can thus be understood that flexibility of terminal ends 12 increase the corresponding work area while reducing the rigidity of cleaning modules 32 bristles.

Yet further features of the various embodiments may include cleaning modules 32 composed of foam or silicone pads, an abrasive surface, jets of fluid and/or tufted bristles. Such bristles may be of varying lengths and stiffness, tapered or shaped and sized in many configurations. For example, in some embodiments tufted bristles are tapered to lengthen toward an end of the plate segments 8 and shorten toward bridge portion 20. In addition, tufted bristles) may be more rigid toward an end of the plate segments 8,8′ and more flexible toward bridge portion 20.

While several embodiments have been described and/or illustrated herein, those of ordinary skill in the art may readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used.

Those of ordinary skill in the art will recognize, or be able to ascertain using no more than routine experimentation, many equivalents to the specific inventive embodiments described herein. For example, obvious inclusion of notches, perforations, edging, flexible layers or adaptive sizing could enhance adaptive flexing of the plate segments 8 or non-rigid members 30.

It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article or material described herein. In addition, a combination of structural features of materials may be incorporated with the described embodiments to enhance or facilitate performance.

1. A mouthpiece for a dental cleaning appliance for simultaneously cleaning one or more teeth in a maxillary dental arch and one or more teeth in a mandibular dental arch of a user, comprising:
an arcuate mouthpiece including a plurality of plate segments configured as H-shaped members having opposing side walls, wherein each of the opposing side walls has a terminal end of a single layer portion extending to a folded end wherein the single layer portion doubles back to form an abutting inner layer of a double layer portion, and wherein the inner layers merge in a bridge portion between the opposing side walls configured so the terminal ends and the folded ends of the opposing side walls are inverted in opposed transverse juxtaposition, and wherein the opposing side walls are split by the bridge portion to form an upper channel dimensioned for receiving at least one of the teeth of the maxillary dental arch is disposed on an upper side of the plate segments and an inverted channel dimensioned for receiving at least one of the teeth of the mandibular dental arch is disposed on the underside of the plate segments beneath the upper channel; and
non-rigid members coupling the plate segments so as to adaptively position an inner surface of the plate segments proximal to a working surface of the teeth in the maxillary dental arch and an inner surface of the inverted channels of the plate segments is proximal to a working surface of the teeth in the mandibular dental arch so as to facilitate adaptive fit of the upper channels and the inverted channels about the teeth in the maxillary dental arch and the teeth of the mandibular dental arch adjacent to the plate segments.

2. The mouthpiece of claim 1, further comprising a base portion interfaced with the plate segments and the non-rigid members to thereby facilitate positioning the arcuate mouthpiece when simultaneously cleaning the working surface of the teeth of the maxillary dental arch and the working surface of the teeth of the mandibular dental arch adjacent to the plate segments.

3. The mouthpiece of claim 2, wherein the base portion is segmented.

4. The mouthpiece of claim 2, wherein the bridge portions of plate segments are differentially spaced such that the plate segments with a descended bridge portion are disposed between plate segments having an elevated bridge portion, and wherein the non-rigid members are dimensioned such that plate segments with a descended bridge portion are proximally spaced between plate segments having an elevated bridge portion and wherein a first series of non-rigid members are sized and spaced to connect edges of the plate segments having an elevated bridge portion and a second series of non-rigid members are sized and spaced to connect the plate segments having a descended bridge portion such that the plate segments having an elevated bridge portion are nested between the plate segments having a descended bridge portion.

5. (canceled)

6. (canceled)

7. The mouthpiece of claim 5, wherein the one or more non-rigid members include a flexible wall portion configured to be deformable when the pneumatic device pressurizes and depressurizes the flexible wall portion.

8. The mouthpiece of claim 5, wherein the non-rigid members comprise one or more bladders configured to be inflatable, and wherein the pneumatic device is capable of pressurizing to inflate the bladders and depressurize to deflate the bladders of the non-rigid members.

9. The mouthpiece of claim 1, wherein the non-rigid members include a moveable element selected from the group consisting of a hinge, a slider, a spring, a memory foam, an elongate beam, a flexible fabric, a silicone pad, and a film.

10. The mouthpiece of claim 1, wherein one or more of the side walls of plate segments are configured for fitting a corresponding geometry of the teeth.

11. The mouthpiece of claim 1, wherein the cleaning modules are selected from the group consisting of a foam pad, an abrasive surface, jets of fluid, a flexible wall, and tufted bristles.

12. The mouthpiece of claim 1, wherein the cleaning modules are tufted bristles, and wherein the tufted bristles are tapered to lengthen toward the terminal ends of the plate segments and shorten toward the bridge portions of the plate segments.

13. The mouthpiece of claim 1, wherein the cleaning modules are tufted bristles, and wherein the tufted bristles are more rigid toward an end of the plate segments and more flexible toward the bridge portion.

14. The mouthpiece of claim 1, wherein the cleaning modules includes apertures for ejecting a fluid.

15. The mouthpiece of claim 8, wherein the fluid is a dental treatment agent.

16. A method for simultaneously cleaning one or more teeth in a maxillary dental arch and one or more teeth in a mandibular dental arch of a user, comprising:
providing an arcuate mouthpiece including a plurality of plate segments configured as H-shaped members having opposing side walls joined by a transverse bridge portion wherein the plate segments are configured such that an upper channel is dimensioned for receiving at least one of the teeth of the maxillary dental arch is disposed on an upper side of the plate segments and an inverted channel dimensioned for receiving at least one of the teeth of the mandibular dental arch is disposed beneath the upper channel and having non-rigid members coupling plate segments so as to adaptively position the upper channel proximal to a working surface of the teeth in the maxillary dental arch and the inverted channel of the plate segments proximal to a working surface of the teeth in the mandibular dental arch adjacent to the plate segments such that one or more cleaning modules are capable of contacting a working surface of the teeth of the maxillary dental arch and the teeth of the mandibular dental arch adjacent to the plate segments;
driving the plate segments such that one or more cleaning modules simultaneously clean the teeth of the maxillary arch and the teeth of the mandibular arch adjacent to the plate segments; and
removing the arcuate mouthpiece when a teeth cleaning operation is complete.

17. A dental cleaning appliance for simultaneously cleaning one or more teeth in a maxillary dental arch and one or more teeth in a mandibular dental arch of a user, comprising:
an arcuate mouthpiece including a plurality of plate segments configured as H-shaped members having opposing side walls, wherein each of the opposing side walls has a terminal end of a single layer portion extending to a folded end wherein the single layer portion doubles back to form an abutting inner layer of a double layer portion, and wherein the inner layers merge in a bridge portion between the opposing side walls configured so the terminal ends and the folded ends of the opposing side walls are inverted in opposed transverse juxtaposition, and wherein the opposing side walls are split by the bridge portion to form an upper channel dimensioned for receiving at least one of the teeth of the maxillary dental arch is disposed on an upper side of the plate segments and an inverted channel dimensioned for receiving at least one of the teeth of the mandibular dental arch is disposed on the underside of the plate segments beneath the upper channel;
non-rigid members coupling the plate segments so as to adaptively position an inner surface of the plate segments proximal to a working surface of the teeth in the maxillary dental arch and an inner surface of the inverted channels of the plate segments is proximal to a working surface of the teeth in the mandibular dental arch so as to facilitate adaptive fit of the upper channels and the inverted channels about the teeth in the maxillary dental arch and the teeth of the mandibular dental arch adjacent to the plate segments;
a driving mechanism connected to the arcuate mouthpiece; and
one or more cleaning modules disposed on the inner surfaces of the plate segments, wherein the driving mechanism is capable of activating the cleaning modules to thereby simultaneously clean the working surface of the teeth of the maxillary dental arch and the working surface of the teeth of the mandibular dental arch adjacent to the plate segments.

18. The dental cleaning appliance of claim 17, wherein the driving mechanism is a pneumatic device.

19. The dental cleaning appliance of claim 18, wherein the driving mechanism is a pneumatic device and wherein the base portion is a bladder.
